(19) United States
(12) Patent Application Publication
(10) Pub. No.: US 2023/0297953 A1
(43) Pub. Date: Sep. 21, 2023

(54) DEVICES, SYSTEMS, AND METHODS FOR FREIGHT LOGISTICS AND ASSET MANAGEMENT

(71) Applicant: Stan Koch & Sons Trucking, Inc., Golden Valley, MN (US)

(72) Inventors: Tim Plonski, Golden Valley, MN (US); David Burkhart, Golden Valley, MN (US)

(21) Appl. No.: 18/109,257

(22) Filed: Feb. 13, 2023

Related U.S. Application Data
(60) Provisional application No. 63/309,514, filed on Feb. 12, 2022.

(51) Int. Cl. G06Q 10/087; G06Q 10/0833; G06Q 10/083

(52) U.S. Cl. CPC G06Q 10/087; G06Q 10/0833; G06Q 10/0838

(57) ABSTRACT

Devices, systems, and methods for unloading a tractor trailer that is loaded with assets are disclosed herein. An example method includes reading a unique identifier that is associated with each asset in the tractor trailer, the unique identifier including asset information. The method includes receiving indicia of the asset information, receiving a manual input of the asset information, and/or for choosing the asset information manually from a list of reference data displayed on the display device. The method includes performing a data comparison of the asset information with reference data stored on the storage to thereby identify the asset in an inventory associated with the reference data. The method includes modifying the inventory based on the data comparison when the asset has reached a destination.

### FIELD OF THE INVENTION

The present application generally relates to the field of software and, in particular, to applications for freight and/or logistics management.

### BACKGROUND

In the truckload transportation industry, reliable arrival of shipments and related information at its destination is important. This much is true for operations involving long-haul and regional truckload transportation and/or carriage. In practice, services such as truckload freight hauling, logistics, warehousing, leasing, live tracing and tracking, on-line image retrieval of shipping documents, and lane optimization are all geared toward this goal or support of this goal. Additional services can include truck and trailer satellite tracking, load tracking, electronic data interchange capabilities, custom reporting delivery, data security, disaster recovery, data imaging, and lane and freight analysis.

### SUMMARY

The Koch Mobile App (the “App”) is used by truck drivers to view their load information, scan documents, get company documents, do workflow processes, and have communication to their dispatcher. The app allows the driver to login and see all this functionality via a menu button, buttons on the bottom of the app, and from the home screen. The App integrates various functions into one application and adds barcode scanning into one or more workflow processes.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, system may include a terminal having a display device and configured to read a unique identifier that is associated with each asset in the tractor trailer, the unique identifier including asset information. System may also include a server in communication with the terminal and a storage, the server configured to perform an unloading process that includes: receiving at least one of indicia of the asset information from a reading of the terminal, receiving a manual input of the asset information, and choosing the asset information manually from a list of reference data displayed on the display device; performing a data comparison of the asset information with reference data stored on the storage to thereby identify the asset in an inventory associated with the reference data; and modifying the inventory based on the data comparison when the asset has reached a destination. Other embodiments of this aspect include corresponding computer systems, apparatus, and computer programs recorded on one or more computer storage devices, each configured to perform the actions of the methods.

Implementations may include one or more of the following features. System where the system is configured to await a manual confirmation entry to start an unloading process. System where the system is configured to intelligently perform a data comparison of at least one of an ETA, a fuel consumption, and an estimated pay with historical data that is referenced by the server and that corresponds to the ETA, the fuel consumption, and the estimated pay. System where the terminal includes at least one of a barcode scanner, a QR code scanner, an OCR scanner, or an RFID chip reader. System may include at least one of a trailer tracking device for tracking a truck assets associated with a truck that is moving the tractor trailer, an electronic logging device, and a toll device. System where the terminal is provided by a mobile device. System where the system is further configured to determine a fill level of the tractor trailer based on the data comparison. System where the system is configured to check whether the tractor trailer is qualified for the assets. System where the system further may include a task list associated with at least one stop along a trip of the tractor trailer, the task list providing at least one of data indicative of the results of the data comparison, a time estimate to a subsequent stop, and a disposition of each asset delivered at the stop. System where may include a fleet user interface, a mechanic interface, and a customer interface. System where the server is further configured to display a list of barcodes associated with a given stop. Implementations of the described techniques may include hardware, a method or process, or a computer tangible medium.

In one general aspect, method may include reading a unique identifier that is associated with each asset in the tractor trailer, the unique identifier including asset information. Method may also include receiving at least one of indicia of the asset information from the reading, a manual input of the asset information, choosing the asset information manually from a list of reference data displayed on the display device. Method may furthermore include performing a data comparison of the asset information with reference data stored on the storage to thereby identify the asset in an inventory associated with the reference data. Method may in addition include modifying the inventory based on the data comparison when the asset has reached a destination. Other embodiments of this aspect include corresponding computer systems, apparatus, and computer programs recorded on one or more computer storage devices, each configured to perform the actions of the methods.

Implementations may include one or more of the following features. Method may include awaiting manual entry prior to the performing the unloading process and confirming the displayed asset information. Method may include generating a task list associated with at least one stop along a trip of the tractor trailer, the task list providing at least one of data indicative of the results of the data comparison, a time estimate to a subsequent stop, and a disposition of each asset delivered at the stop. Method may include determining a fill level of the tractor trailer based on the data comparison. Method may include displaying a list of barcodes associated with a given stop. Implementations of the described techniques may include hardware, a method or process, or a computer tangible medium.

In one general aspect, control module may include prompt a user to read a unique identifier that is associated with each asset in the tractor trailer, the unique identifier including asset information. Control module may also receive at least one of indicia of the asset information, a manual input of the asset information, and user selection of asset information manually selected from a list of reference data displayed on the display device. Module may furthermore perform a data comparison of the asset information with reference data stored on the storage to thereby identify the asset in an inventory associated with the reference data. Module may in addition modify the inventory based on the data comparison when the asset has reached a destination. Other embodiments of this aspect include corresponding computer systems, apparatus, and computer programs recorded on one or more computer storage devices, each configured to perform the actions of the methods.

Implementations may include one or more of the following features. Control module where the control module is further configured to await manual entry prior to the performing the unloading process and confirming the displayed asset information. Control module where the control module is further configured to generate a task list associated with at least one stop along a trip of the tractor trailer, the task list providing at least one of data indicative of the results of the data comparison, a time estimate to a subsequent stop, and a disposition of each asset delivered at the stop. Control module where the control module is further configured to determine a fill level of the tractor trailer based on the data comparison and to display a list of barcodes associated with a given stop. Implementations of the described techniques may include hardware, a method or process, or a computer tangible medium.

### BRIEF DESCRIPTION OF THE DRAWINGS

The above-mentioned and other features and advantages of this disclosure, and the manner of obtaining them, will become more apparent, and will be better understood by reference to the following description of the exemplary examples taken in conjunction with the accompanying drawings, wherein:

FIG. 1 is a block diagram schematic representation of a data processing system, according to principles of the present disclosure; and

FIGS. 2A-2Z and FIGS. 3-16 are illustrative pages from various graphic user interfaces of an application, according to principles of the present disclosure.

Corresponding reference characters indicate corresponding parts throughout the several views. Although the drawings represent examples of various features and components according to the present disclosure, the drawings are not necessarily to scale and certain features can be exaggerated in order to better illustrate and explain the present disclosure. The exemplification set out herein illustrates an example of the invention, and such an exemplification is not to be construed as limiting the scope of the invention in any manner.

### DETAILED DESCRIPTION OF VARIOUS EMBODIMENTS

For the purposes of promoting an understanding of the principles of the present disclosure, reference is now made to the examples illustrated in the drawings, which are described below. The exemplary examples disclosed herein are not intended to be exhaustive or to limit the disclosure to the precise form disclosed in the following detailed description. Rather, these exemplary examples were chosen and described so that others skilled in the art can utilize their teachings. It is not beyond the scope of this disclosure to have a number (e.g., all) the features in a given example to be used across all examples.

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

Known asset management solutions are found as standalone applications that do various functions, such as repositories for load information, scanned documents, and company documents as well as workflow processes and communication to dispatch. To the contrary, the present disclosure integrates these functions and more into a single application with additional features such as asset management and workflow processes. These features are particularly useful in the truckload transportation industry. For instance, a major workflow processes includes the ability for a driver to scan product barcodes. Some known apps scan driver documents, other apps have truck drivers scan images for trailer inspections, warehouses and distribution centers can track assets at their stationary locations. But these solutions do not integrate these and other various functions into workflow barcode scanning.

The below examples are grounded in the trucking arena for sake of conciseness but should not be limited as such. Indeed, one skilled in the art will appreciate that the principles of the present disclosure will be more, less, or equally useful in other arenas.

An asset management system for truckload transportation as disclosed herein can allow drivers to send documents and complete workflow processes and utilize barcode scanning. For instance, a customer can request shipment of certain assets that have an associated barcode. These barcodes can be sent to a truckload transportation provider and used during loading and/or unloading to ascertain what is on a trailer carrying the assets and what has been unloaded off the trailer at any time. The barcodes can be associated with the trailer that will currier the assets to their destination. Loading and unloading transactions can be captured by the App and can have specific tags, such as “refused,” “received,” or “other” that are communicated with the customer to let them know how the asset has been dispositioned. In addition, this asset management system can tie in GPS location and other functions of the application noted above. Additional information such as the number of barcode scans, timing between scans, and other logistical information can also be tracked for optimization, efficiency, and other purposes.

Asset Identification and/or Tracking (“AIT”)

Advantageously, each user interface may use an AIT subsystem. Such a subsystem can be operable to manage assets via unique identifiers (e.g., barcodes, QR codes, and the like). These unique identifiers can be designed to be scanned and read into computer memory and contains asset information (e.g., identification, related information, general information, and the like) about the asset that it labels. These labels are generally affixed to the asset at least until it reaches a final destination, as a lifetime identifier, or some subset of either. As such, terminals of the asset management system can function as or otherwise include a scanner (e.g., a camera, light scanner, or the like) with local or remote access to a computer memory that contains asset information. The terminal then can facilitate (e.g., prompt or itself determine) asset information about the asset using a unique identifier. As discussed elsewhere herein, such information can be useful when paired with functions of various user interfaces, examples of which are provided below.

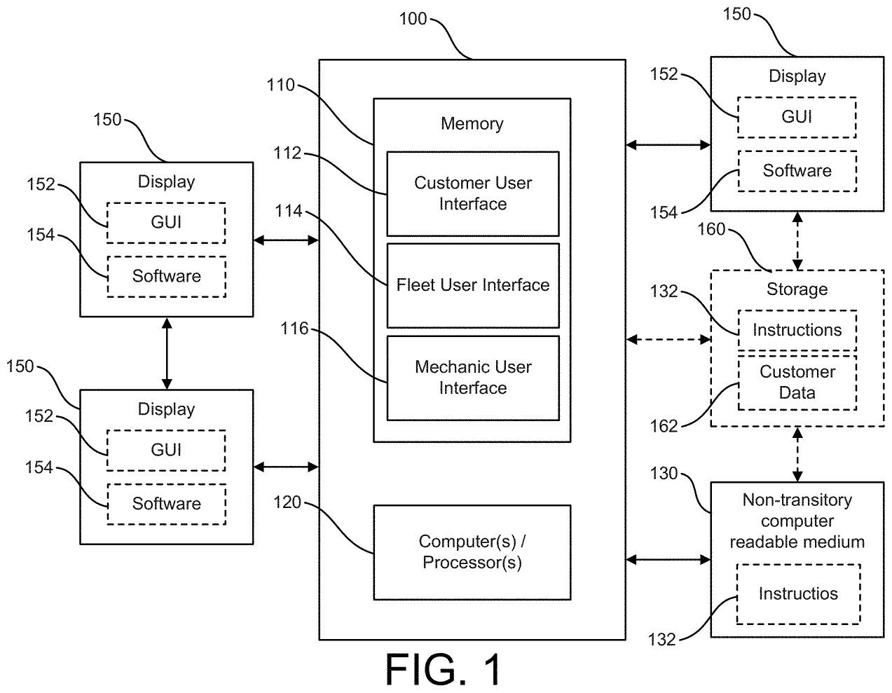

A data processing system 100 for intelligent asset management, as shown in FIG. 1, can employ principles of the present disclosure. For example, such a data processing system 100 can include a memory 110 for storing one or more user interfaces (e.g., a customer user interface 112, a fleet user interface 114, and a mechanic user interface 116). In addition, or in alternative, the data processing system 100 can include a processor 120 or a computer 120 configured to access the memory 110. In this regard, exemplary procedures in accordance with the present disclosure described herein can be performed by a processing arrangement (e.g., one or more processors 120), a computing arrangement (e.g., one or more computers 120), or both. Such arrangements can be, e.g., entirely or a part of, or include, but not limited to, a computer 120, a processor 120, or both, each of which can include, e.g., one or more processors 120 (e.g., CPUs or microprocessors), and use a non-transitory computer-readable medium 130 (e.g., RAM, ROM, hard drive, or other storage device) with instructions 132 stored thereon.

The processor 120 can be in communication with a display 150, which, according to some examples of the present disclosure, can be a touchscreen running the App and configured to input (e.g., via user interfaces 112, 114, and 116) information to the processor 120 in addition to outputting information from the processor 120. Further, the display 150, the storage 160, or both can be used to display, store, or both display and store customer data 162 (e.g., conversation transcripts, categories, history of user input, etc.) in a format that is either or both user-readable and user-accessible. In examples, the data processing system 200 can be a server running a private cloud platform or a multitenant platform. The display can be provided by an access terminal as discussed further below.

The display 150 can include a graphic user interface 152 (GUI 152) and a software 154 as further described below. The software can be the App and the GUI can mirror or provide input to the user interfaces 112, 114, and 116 of the App. User intervention can be facilitated via the display 150. For example, the display 150 can include software 154 in communication with the server and the GUI 152 with which to prompt a user and receive a user input (e.g., an analog or digital input). In examples, the display 150 is configured to optionally allow for user input to confirm or modify the inputs and results from the processor 120, modify criteria used by the processor 120, or the like. In other examples, the display 150 can be configured to allow any combination of these functions and more as these functions are just some of many examples one skilled in the art will appreciate

### Access Terminal(s) (or Terminal(s))

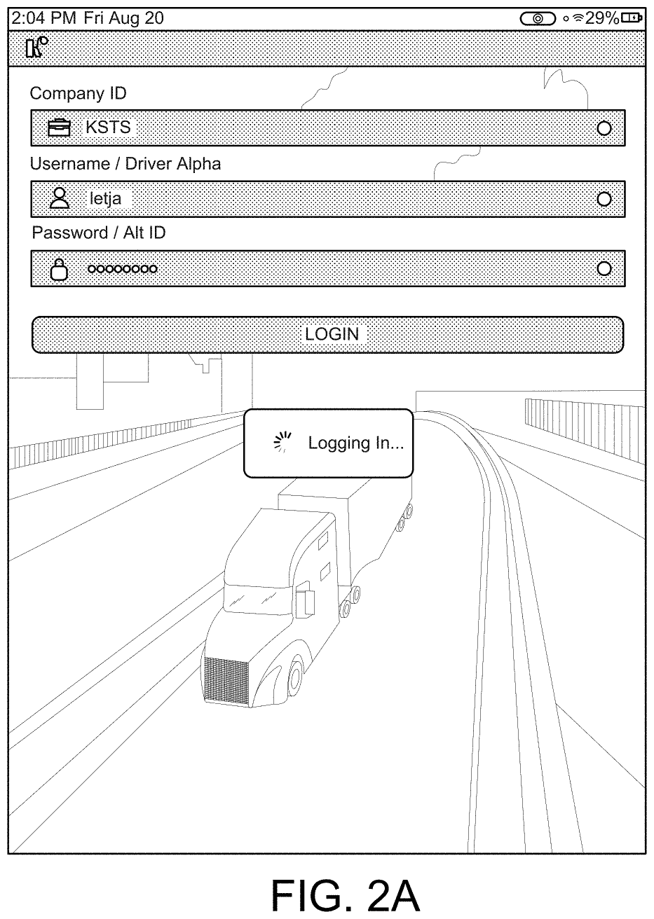

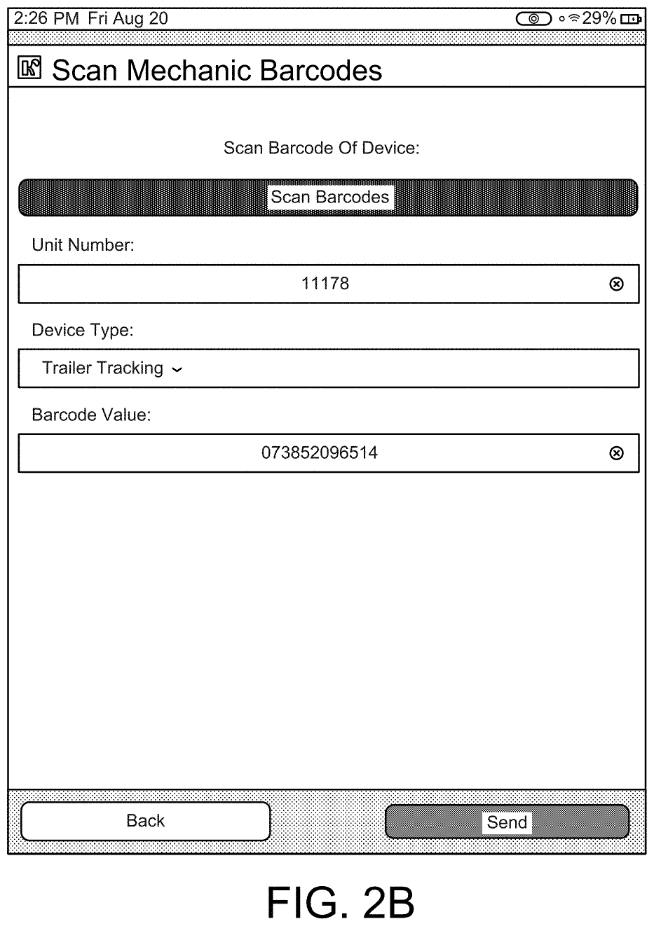

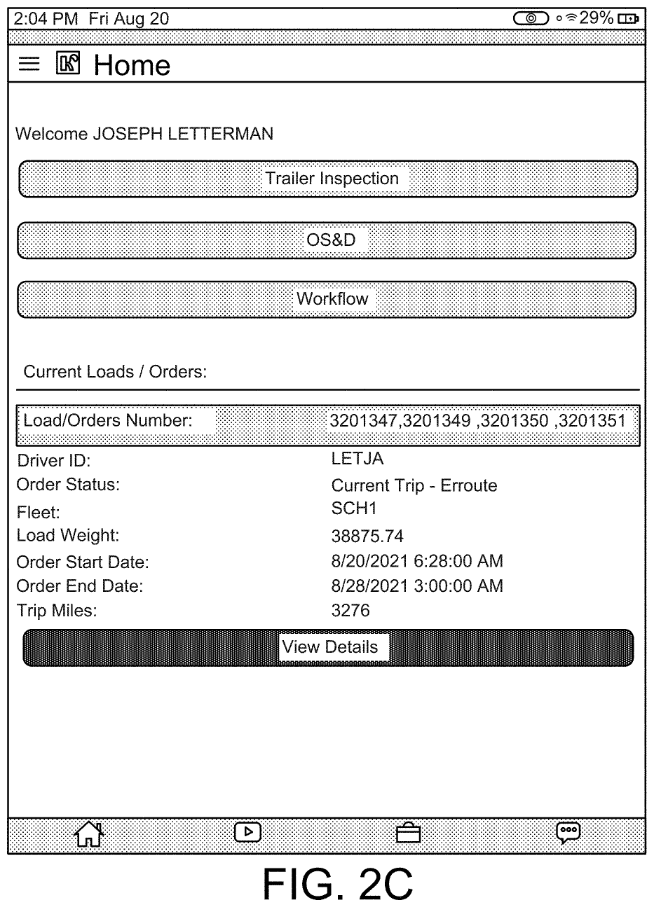

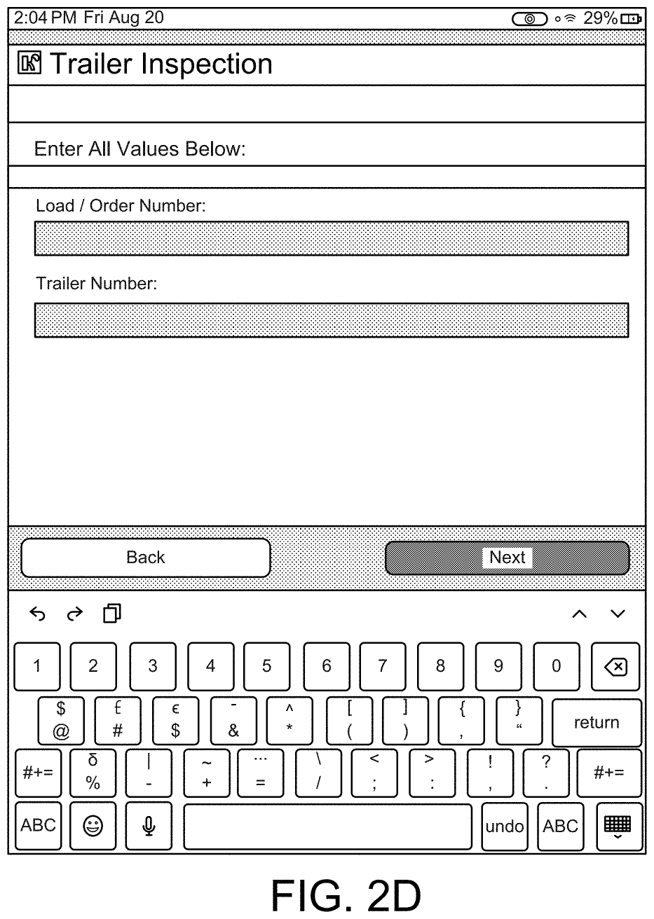

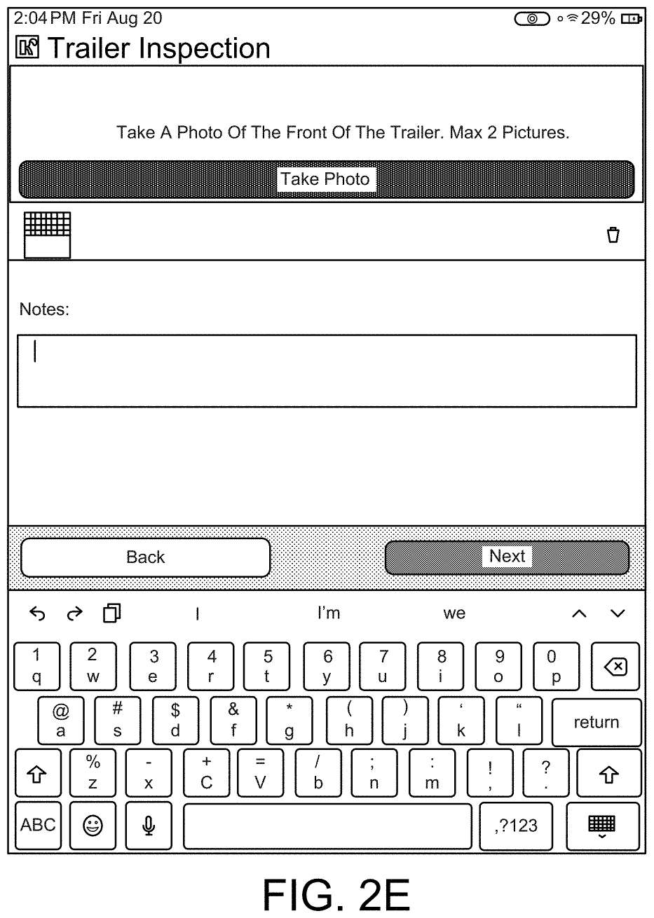

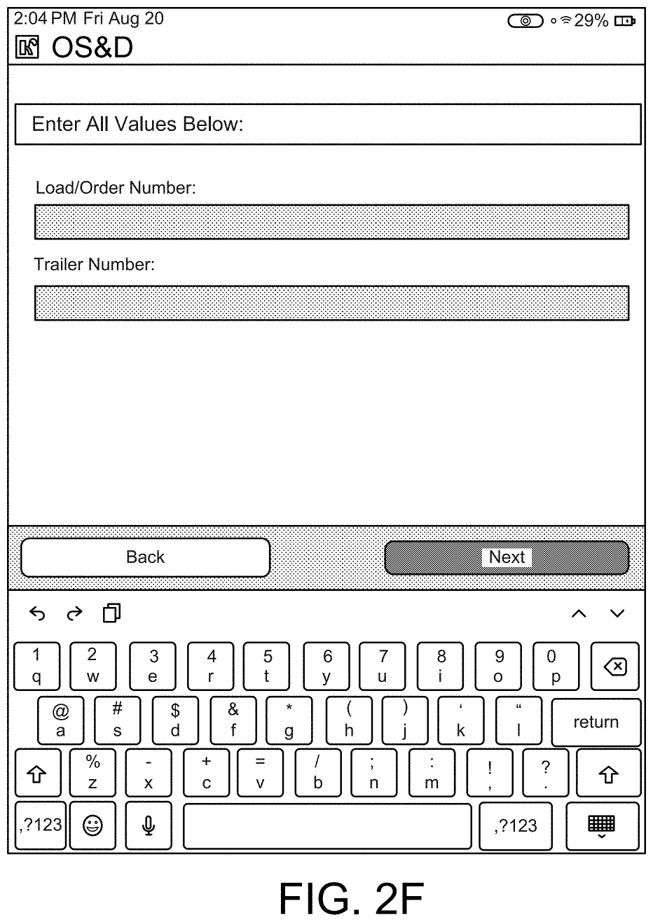

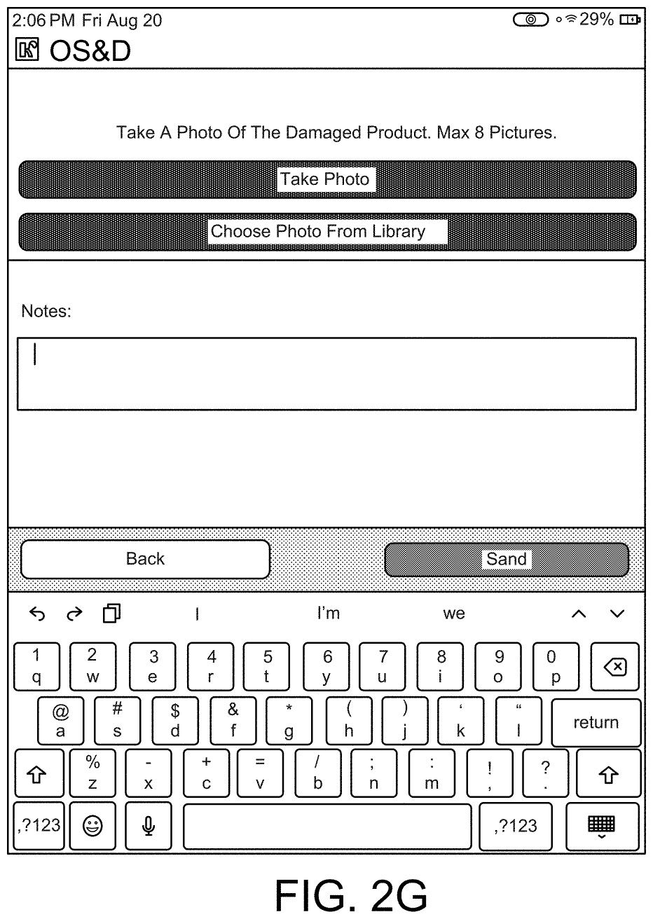

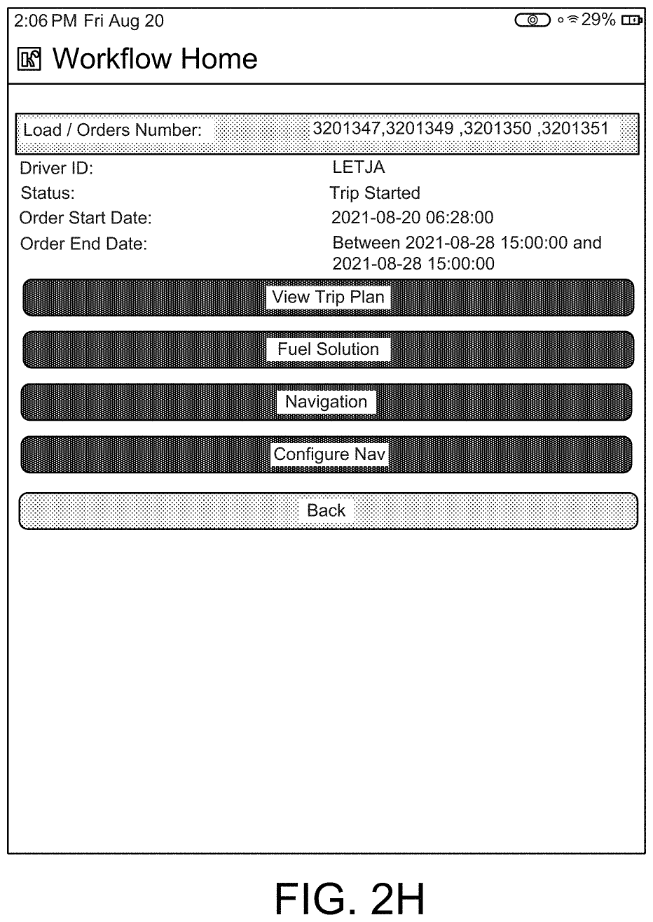

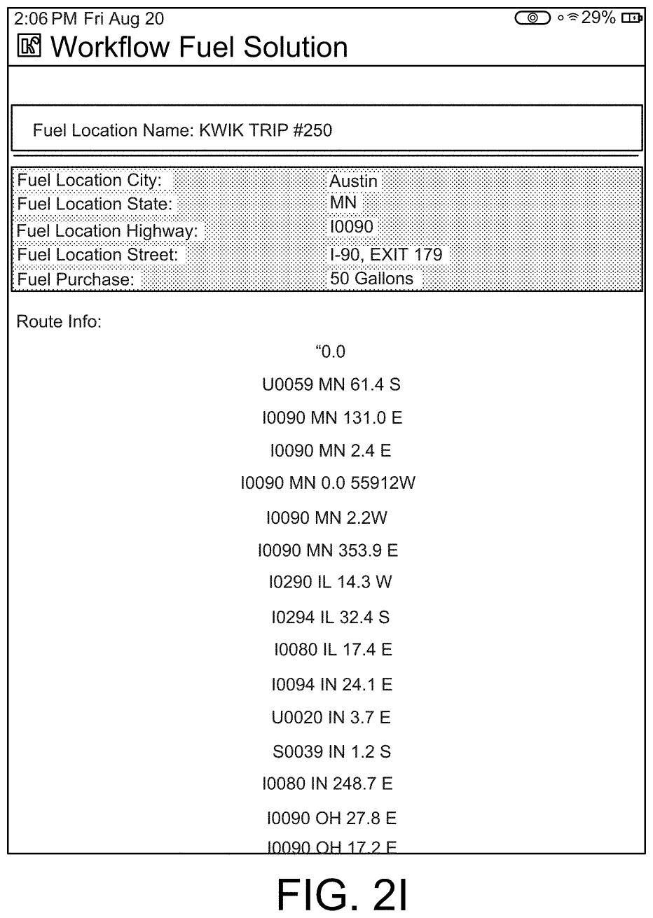

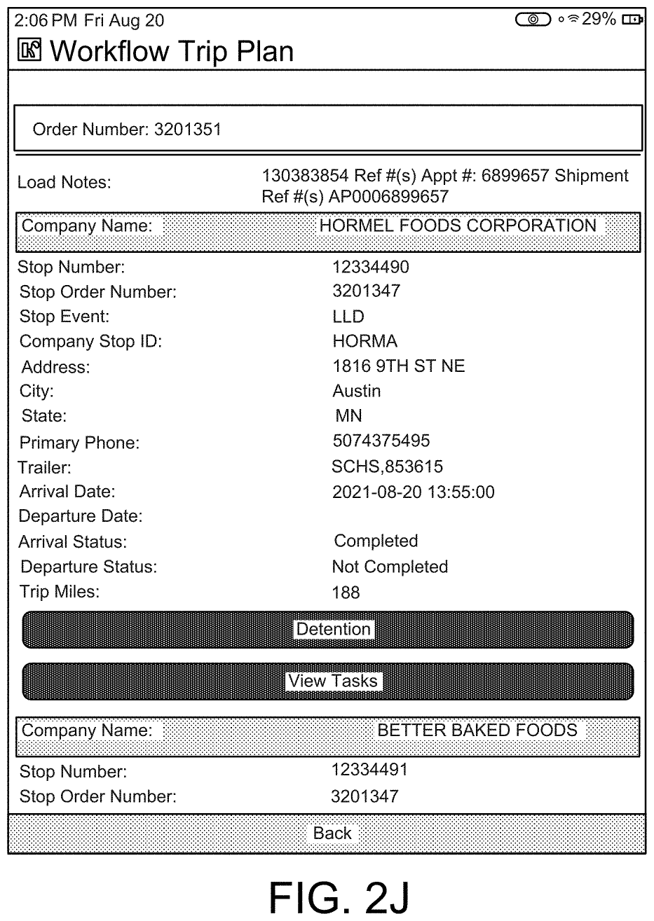

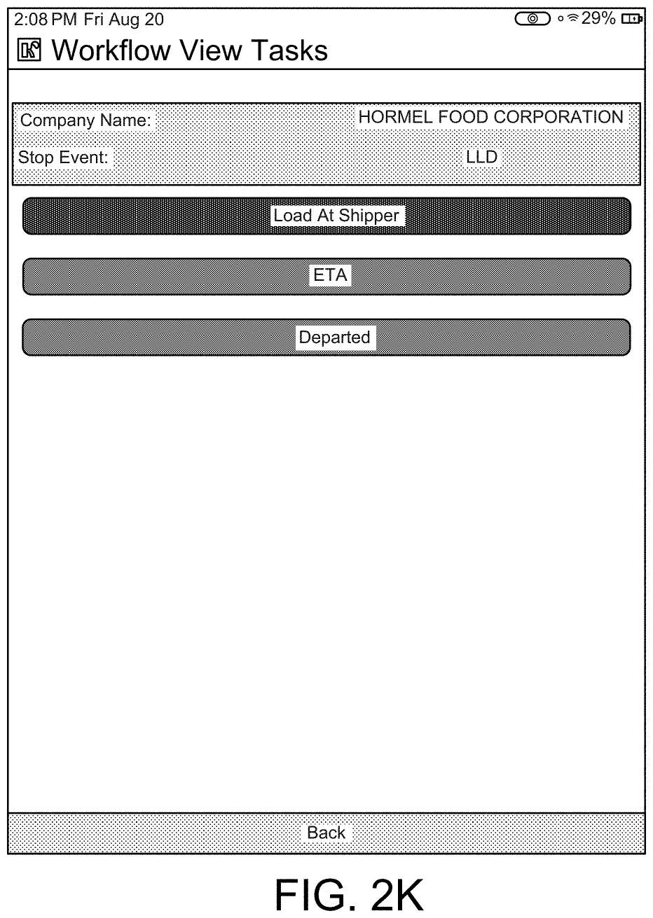

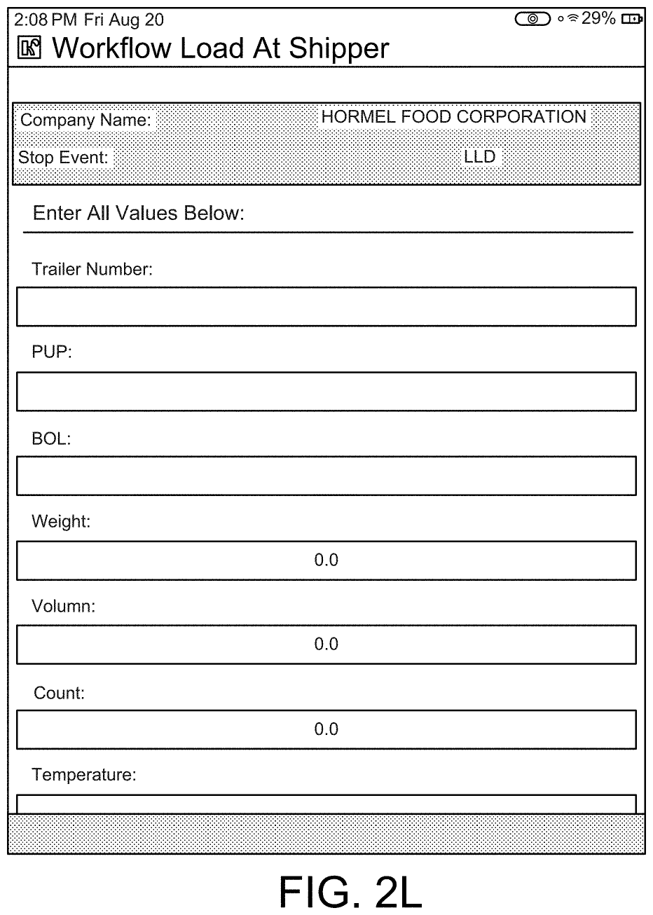

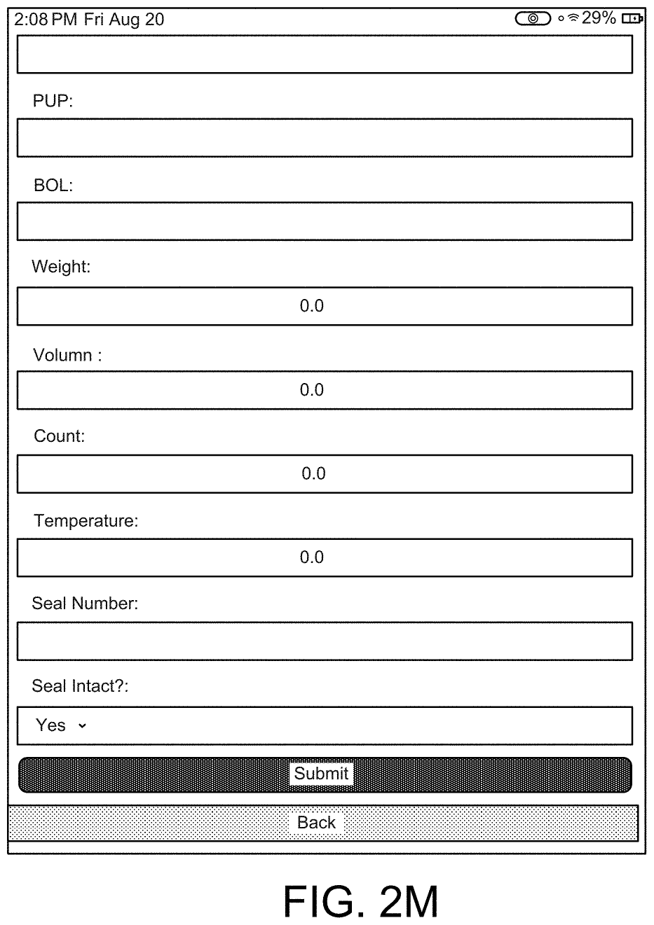

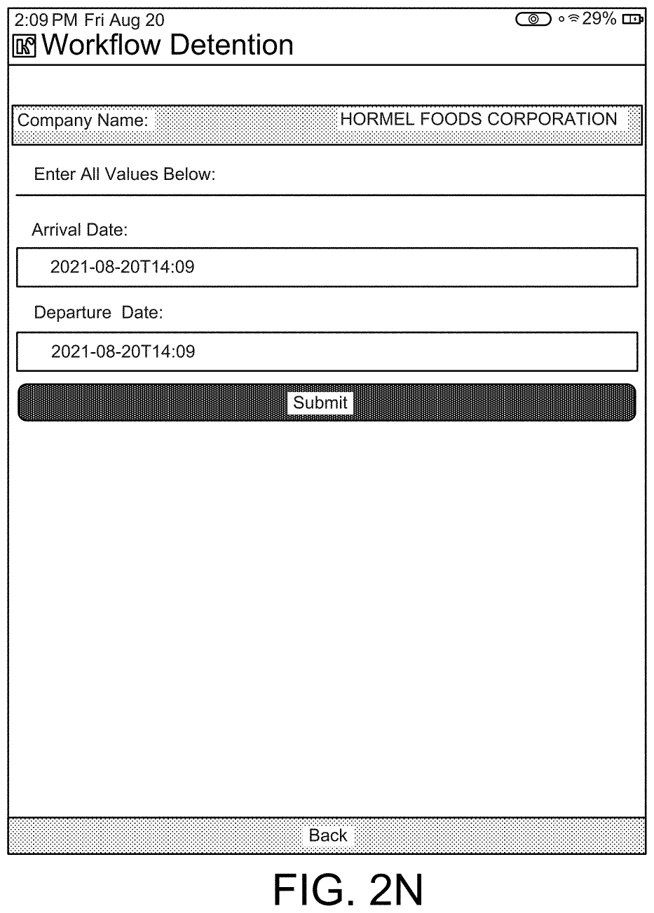

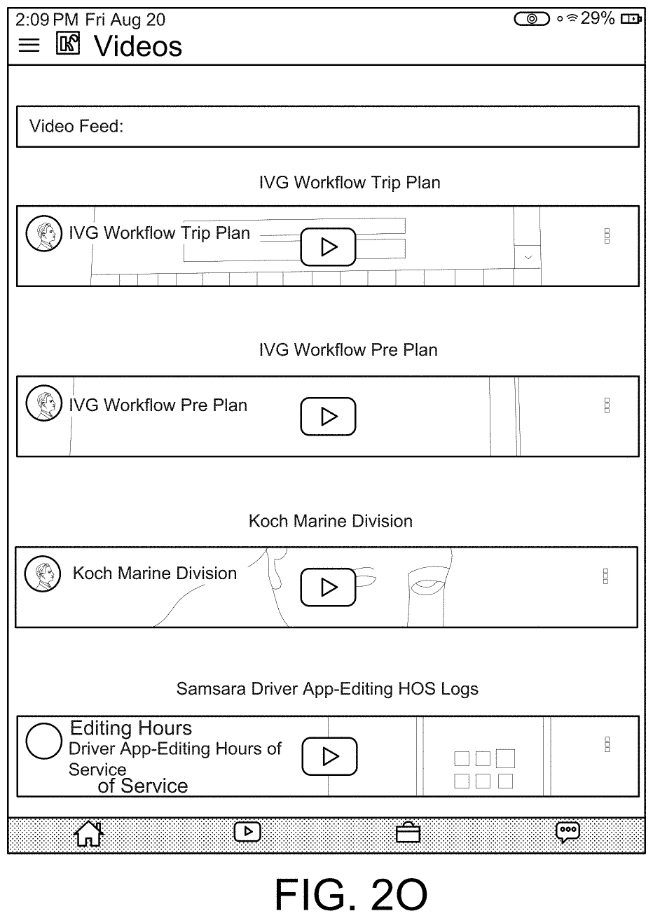

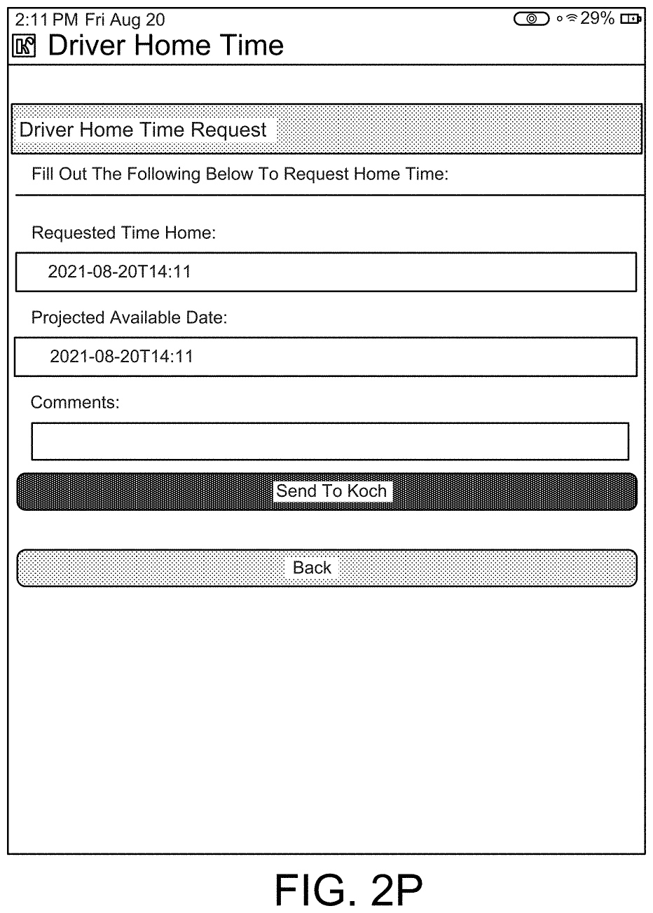

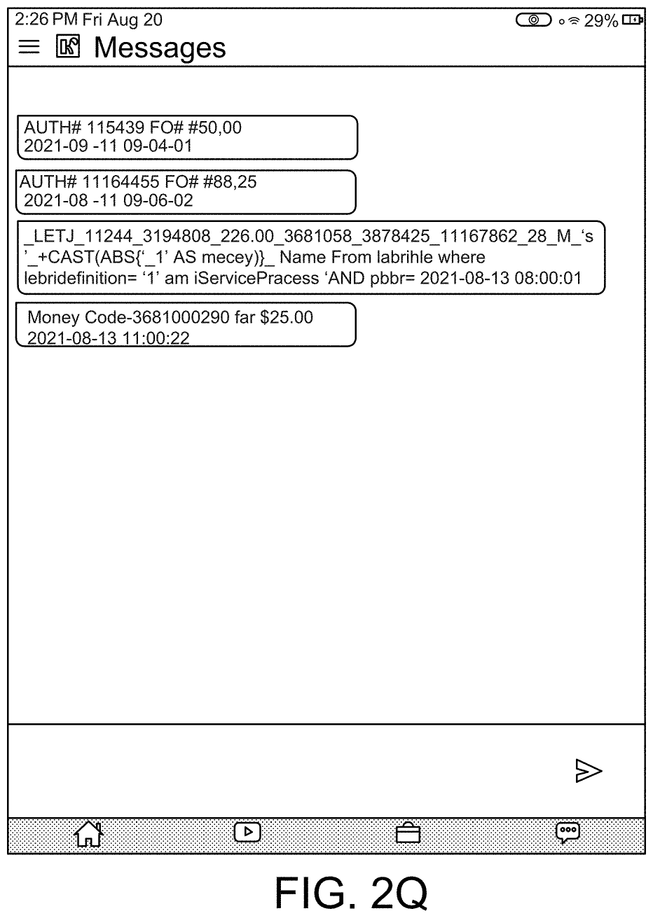

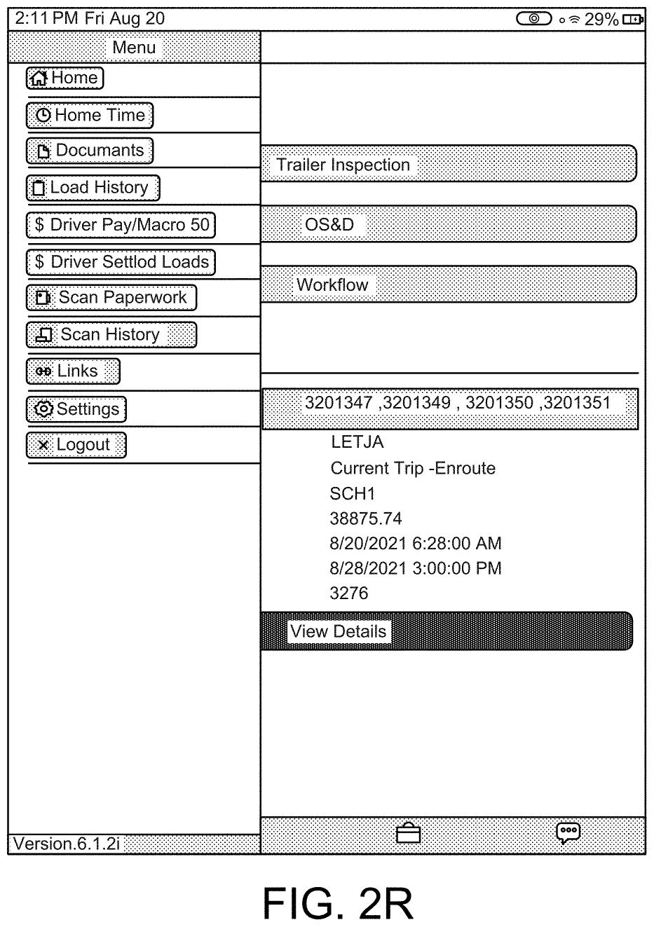

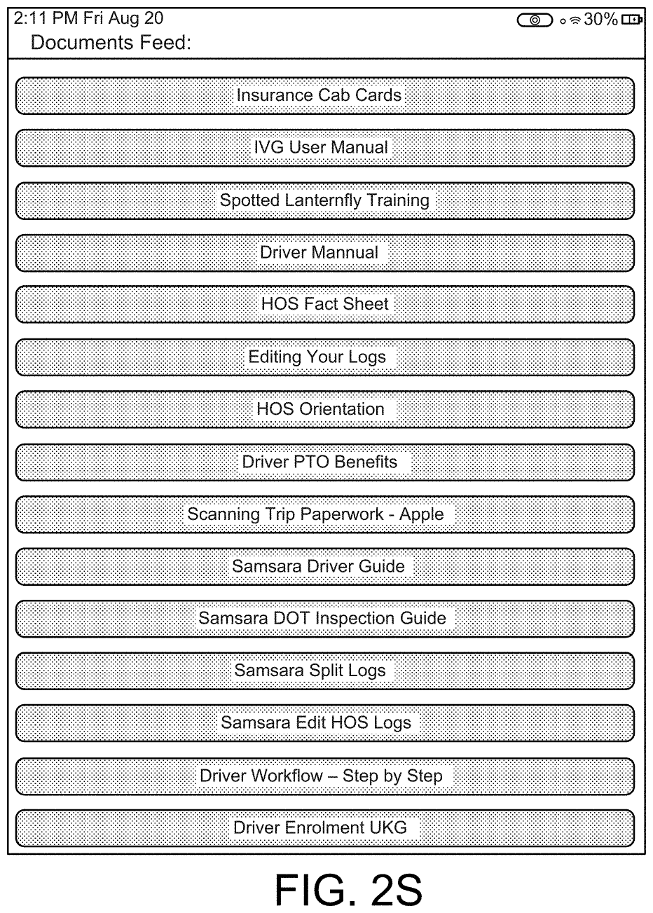

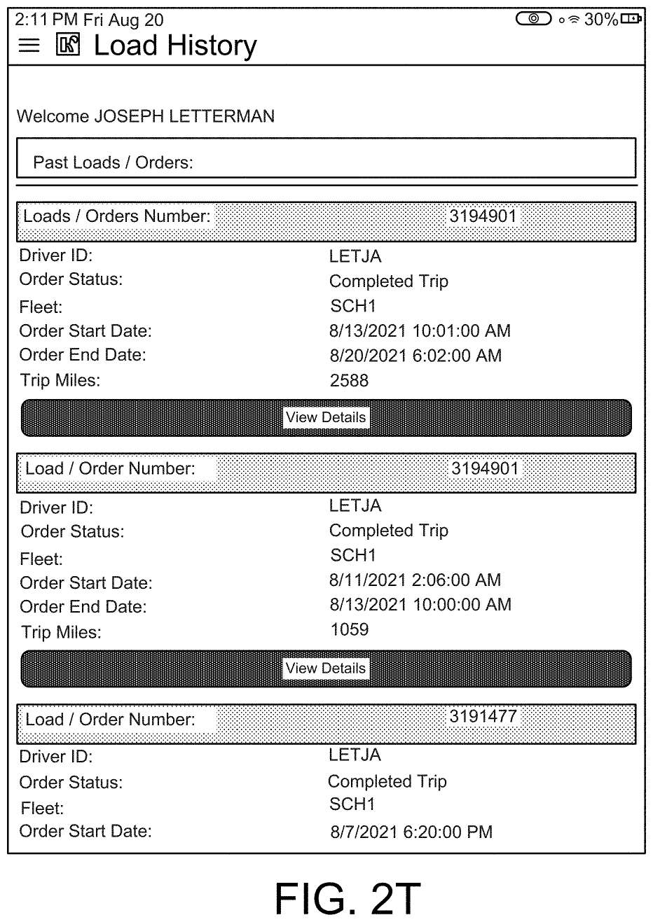

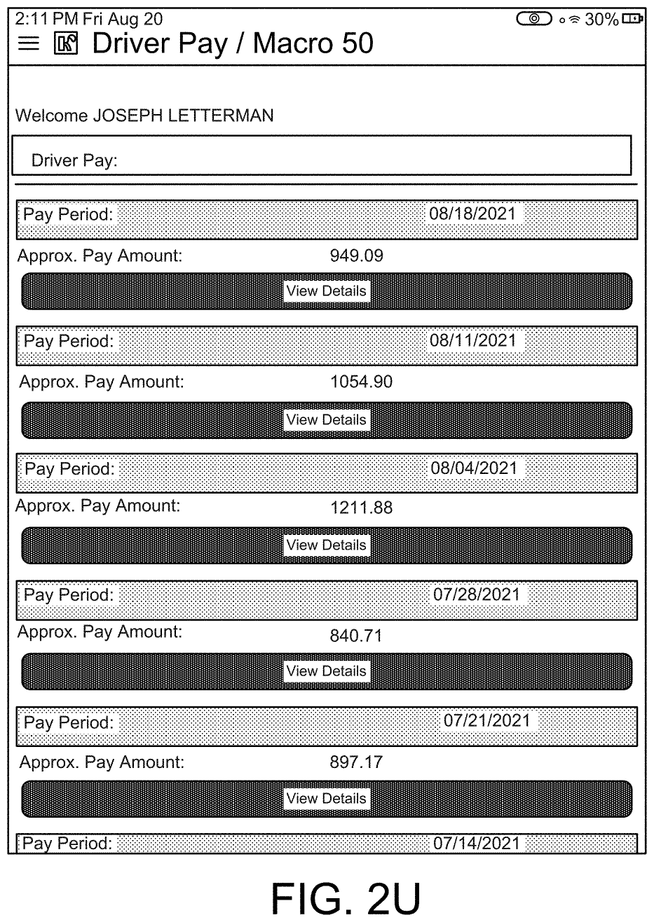

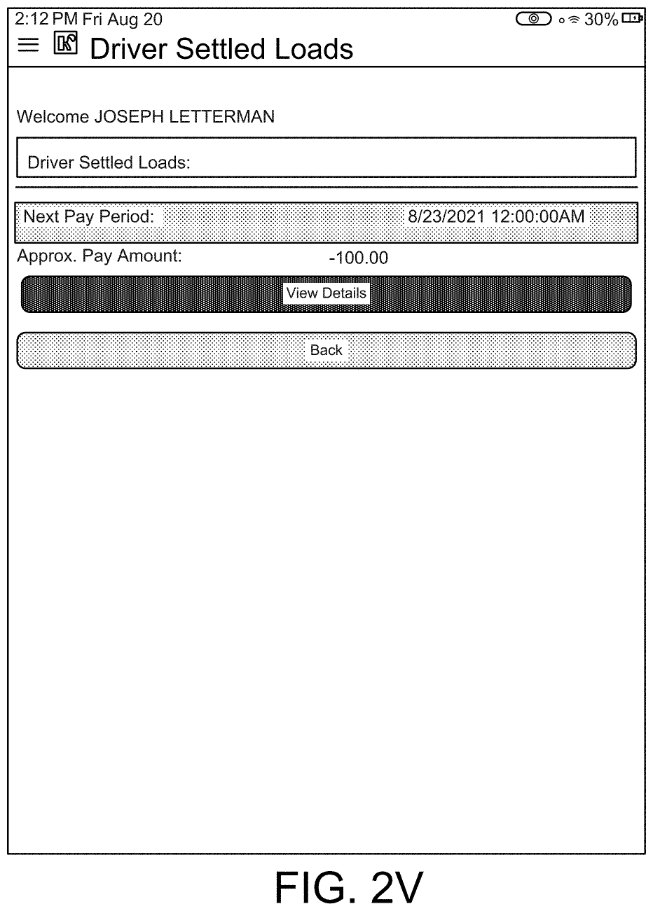

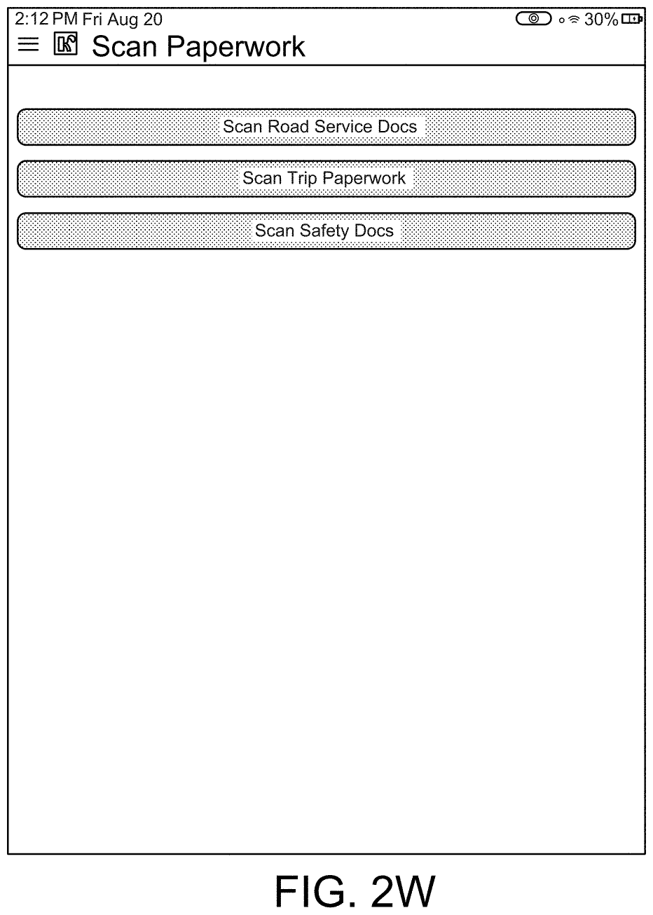

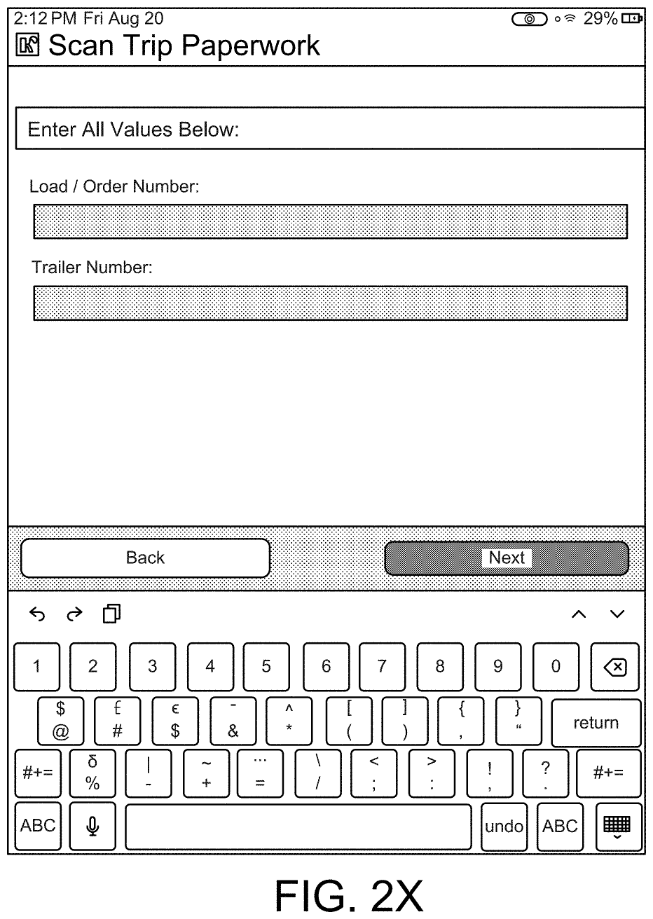

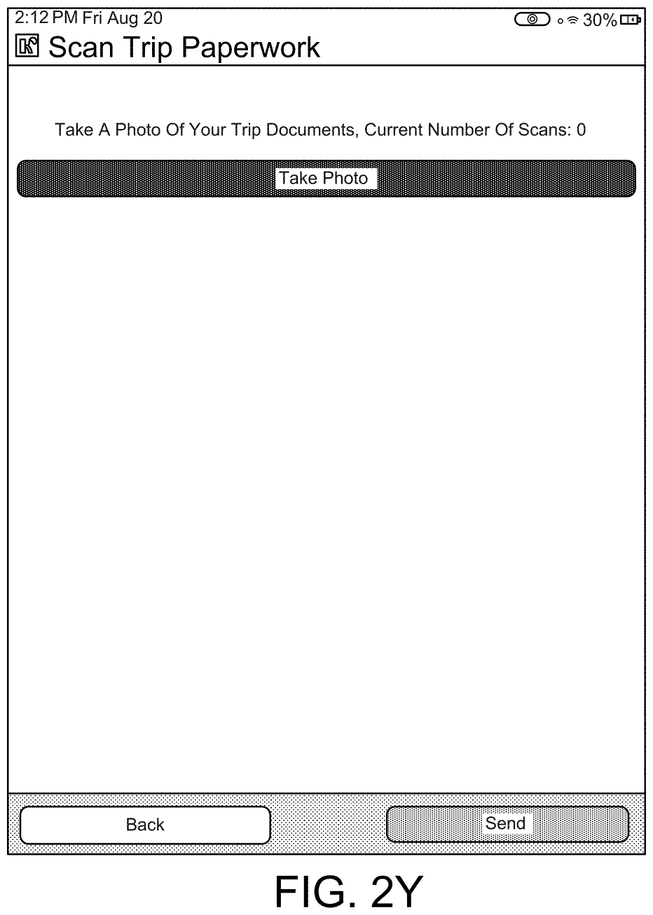

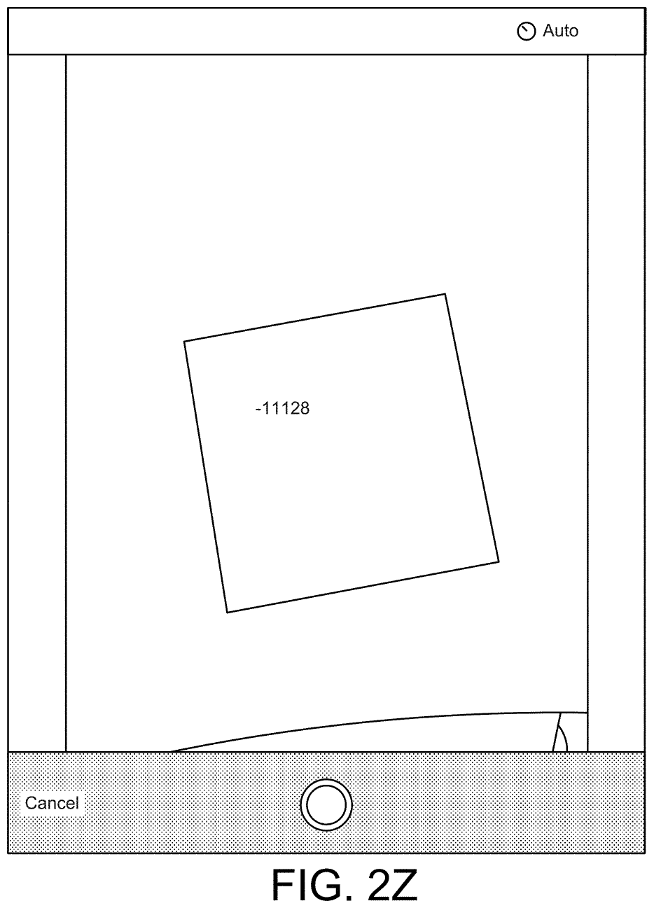

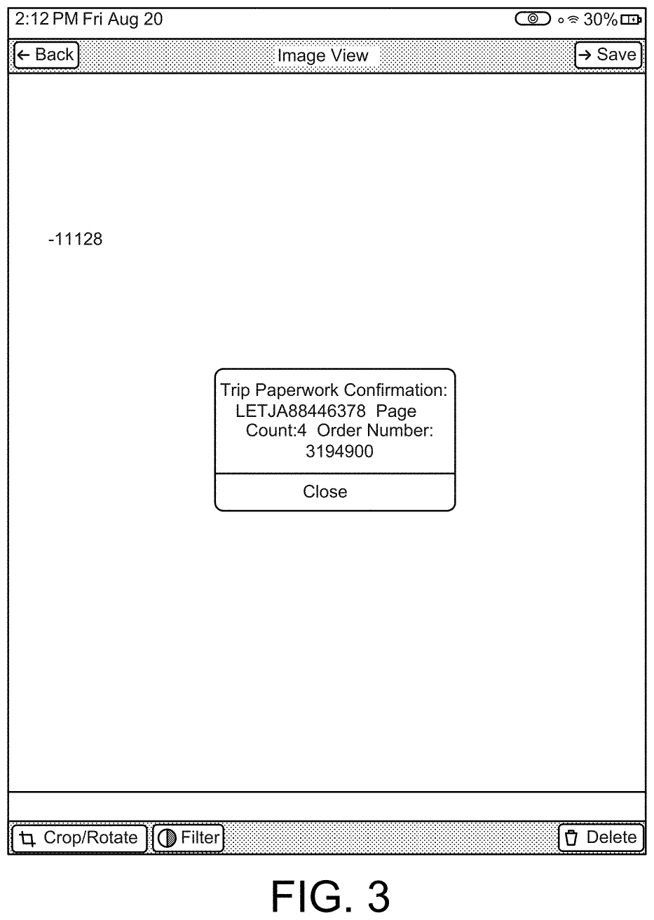

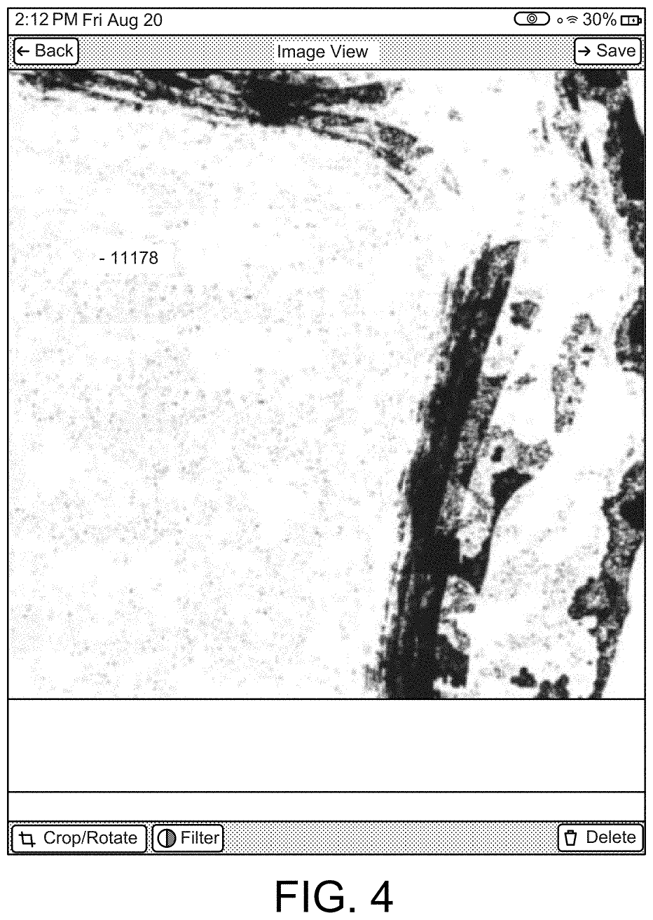

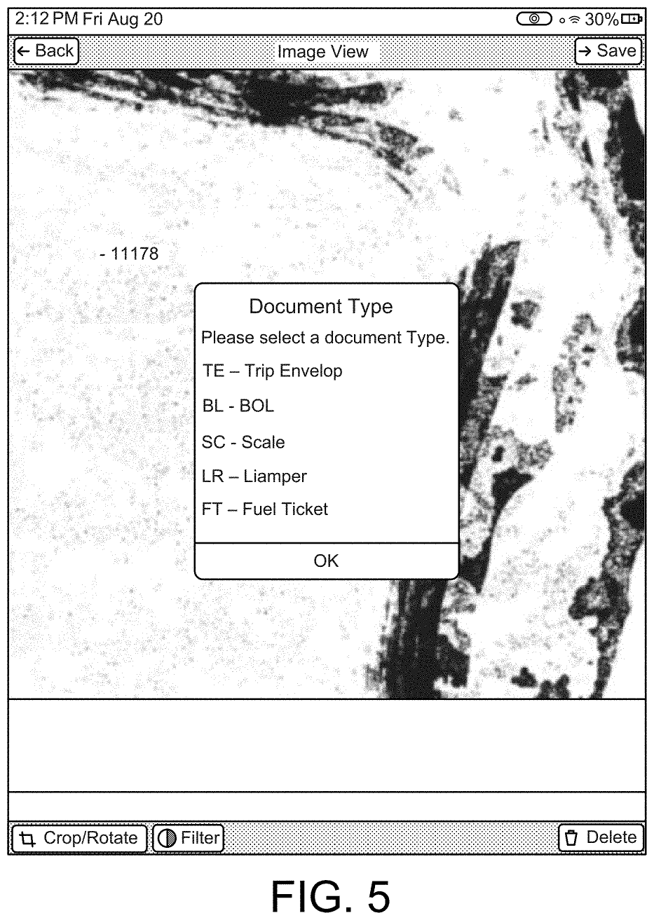

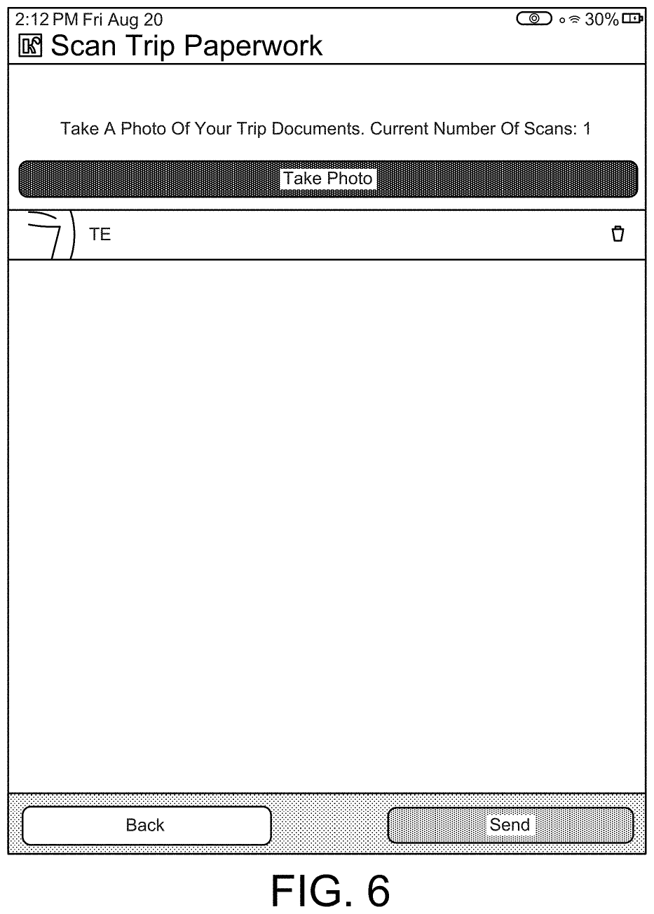

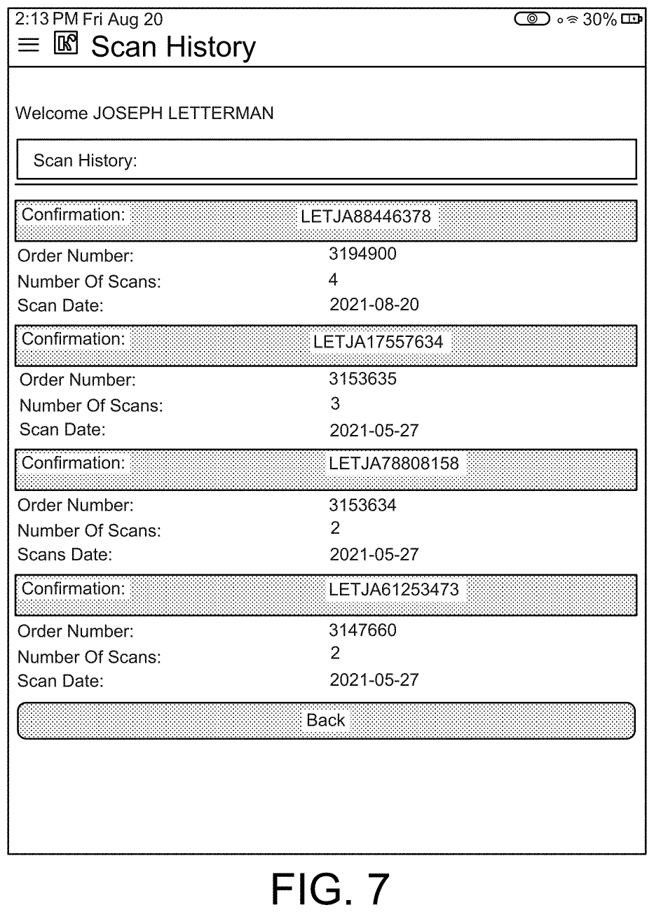

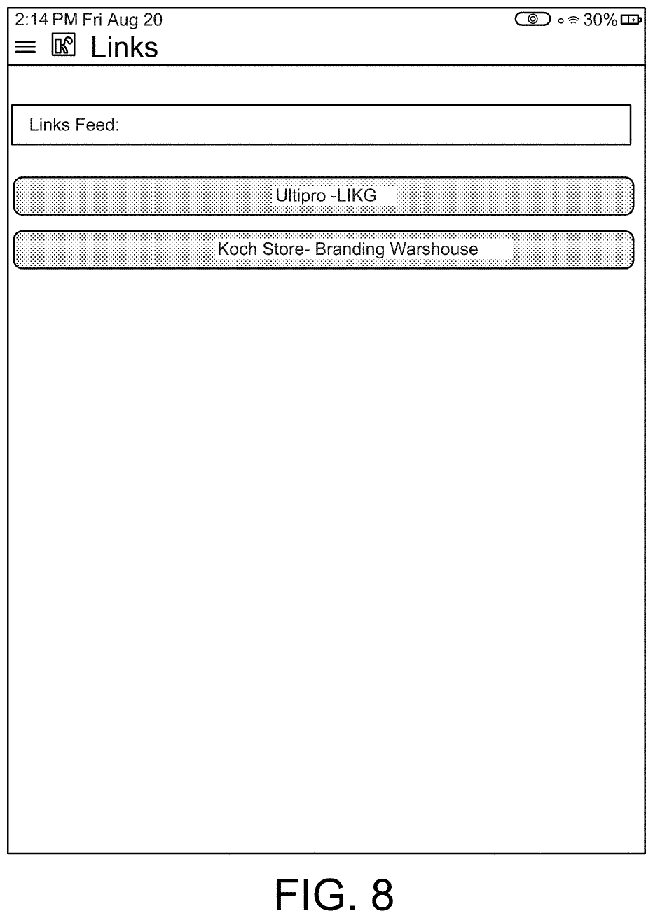

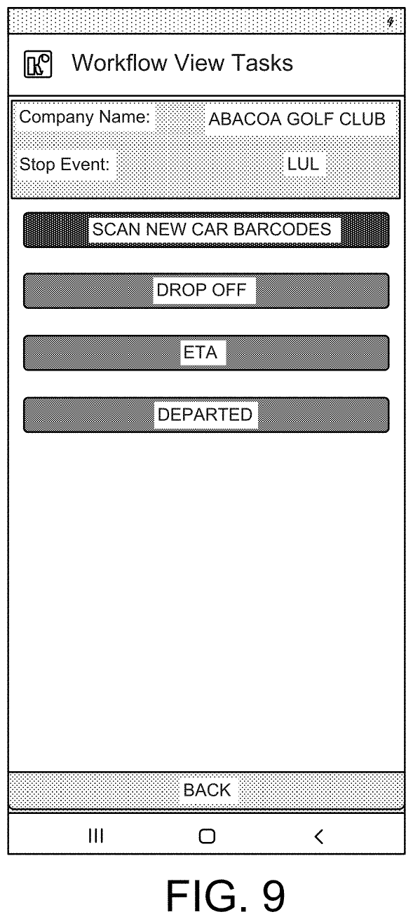

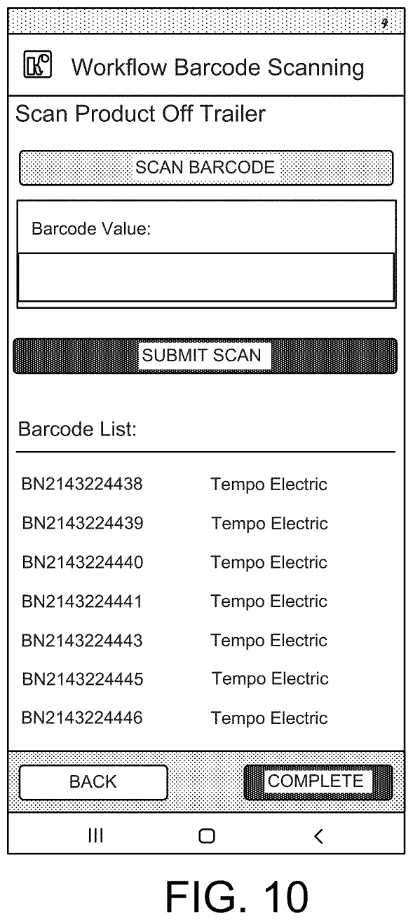

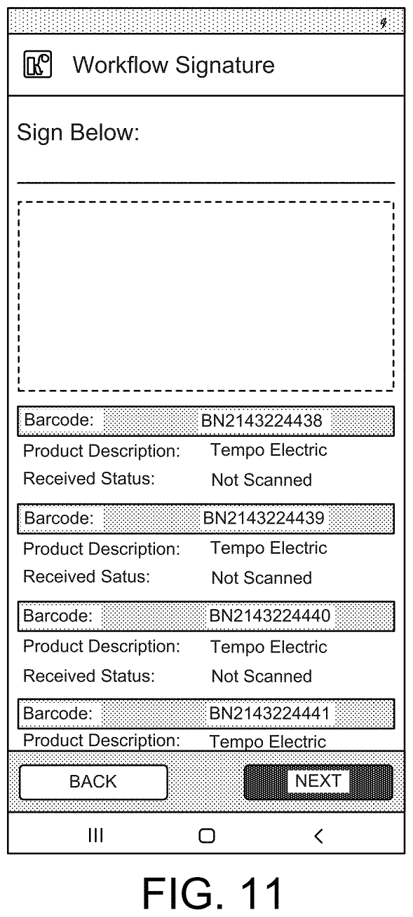

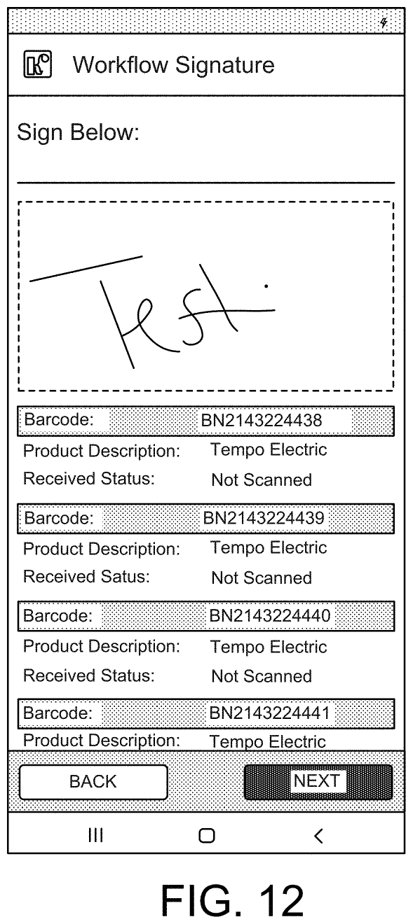

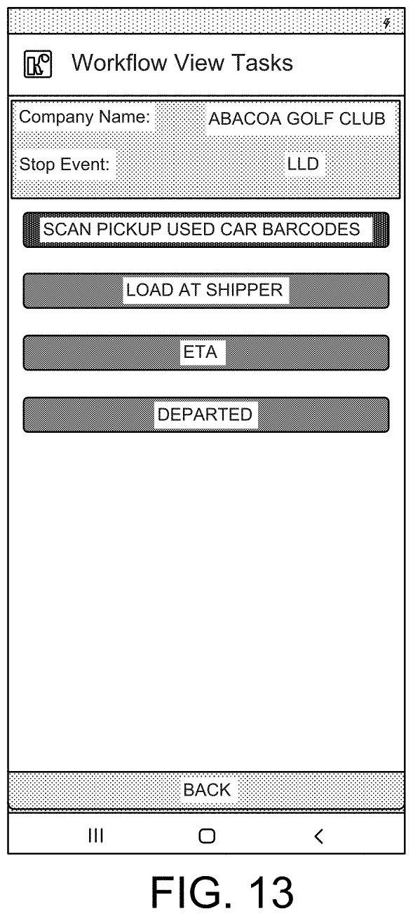

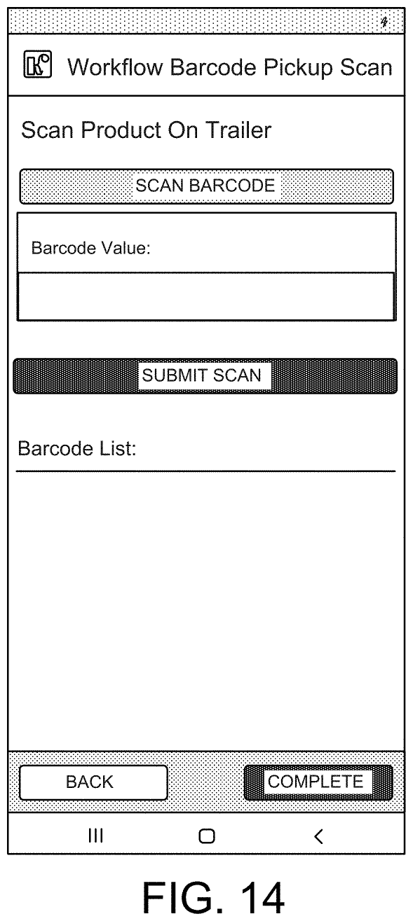

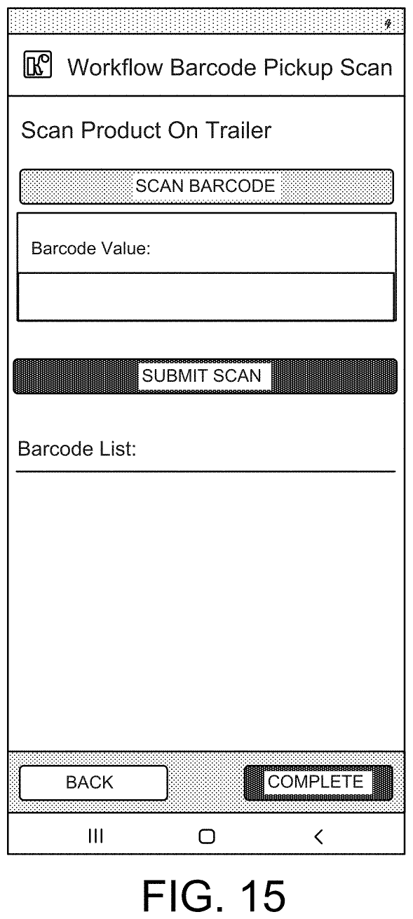

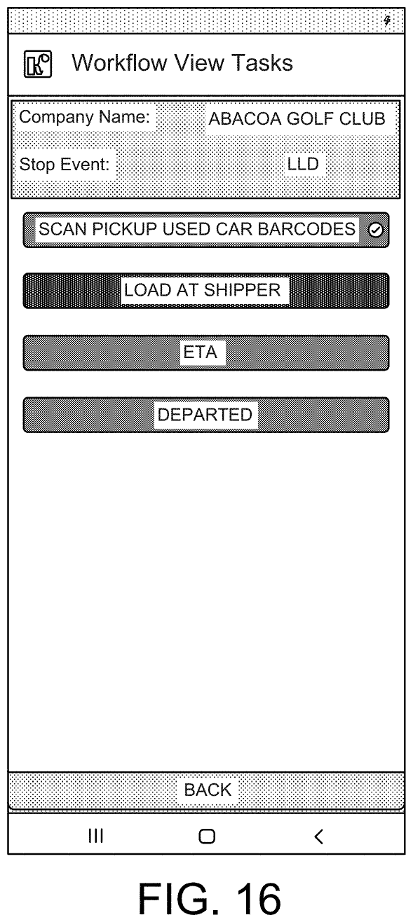

FIGS. 2A-2Z and FIGS. 3-16 show various pages from various graphic user interfaces of the App, according to principles of the present disclosure. The following discussion is made without reference to any particular one of these figures for conciseness and ease of discussion. One skilled in the art will readily associate the below discussion with the content of these figures.

Without reference to a particular figure, a terminal for interfacing with such an asset management system (also sometimes referred to herein as “the system”) can be configured to generate the pages shown in FIGS. 2A-2N. As seen here, there is an option for the user to input a Company ID, Username/Driver Alpha, and Password/Alt ID. As one skilled in the art will appreciate, the asset management system may present a user interface that is customizable to the type of user, such as for a customer (retailer, wholesaler, etc.), a driver, and a mechanic. As such, and examples, it can be said that each user interface is protected by login credentials or that each user has access to only the user interface(s) for which their credentials are authorized. Using a bottom toolbar, the user can access various useful videos (e.g., training videos, how-to videos, safety videos, and the like).

Using said user interface and input examples, use of the terminal is straightforward. Input into the company ID field allows the system to determine which user interface the user intends to log into and by extension which user interface to display upon a successful login. Input into the username/driver Alpha field allows the system to determine which user associated with the company ID is accessing the asset management system. And input into the password field allows the asset management system to pass or gain admission to the user with some level of security (single or multi use passwords, two factor authentications, and the like).

Access to the system begins upon successful completion of these fields, and on the other hand, unsuccessful completion of these fields will not allow access to the system. In this regard, it can be said that the asset management system serves as a portal for commonly interfacing entities: fleet drivers, fleet operators/departments, customers, and mechanics. In a sense, terminals running the App can or otherwise accessing the asset management system can form a multitenant architecture that includes a server that is accessed directly by the terminal and/or via a cloud (e.g., a cloud server). Such a multitenant architecture can include modules that are accessible via the App and/or send/receive (or function as a transceiver to) data in storage that is accessible by the server. Data (e.g., various assets) are stored on the storage for various uses, included use with various interfaces. These concepts and more are discussed in detail below.

A menu button, shown in the upper left-hand corner of the home page as a hamburger button, can reveal several useful functions of the App for use by the user. For instance, selecting the menu button can allow the user to navigate to the following pages: home, home time to request time off or away, load history, driver pay (Macro 50), driver settled loads, document scan, scan history, links to various websites (e.g., for accessing policy and procedure documents or fleet websites), and setting for the App. The load history page can display all completed loads (e.g., settled and unsettled). The estimated pay page can display a driver's estimated pay over a pay period based on a variety of factors, including completed loads, settled loads, pricing associated with the load, and the like. In instances, the estimated pay can reference historical pay data using reference data and/or artificial intelligence for an accurate pay estimate. In general, a Driver may wish to scen paperwork such as service documents, trip documents (e.g., fuel receipts, delivery dispositions, etc.), and safety documents (e.g., Hours of Service data). Scanned paperwork can be associated with a loading trailer number and stored for a given trip. To save space, scanned images may be rendered in black-and-white. The scan history can include a confirmation that the scan was received and/or sent to a customer as described in more detail elsewhere herein.

### Customer User Interface (“CUI”)

Referring to deliveries as an example, a customer user interface can be used as the start and end points of services provided by a fleet. To start, users of the CUI (“customers”) who have successfully logged in can use the CUI to generate or modify existing asset lists. In examples, these asset lists can be used as a reference of customer asserts for which customers are contracting the fleet to move from one location to another. In the interim of their delivery, customer assets can be tracked. For instance, the CUI can provide its users with an indication of whether their customer assets that are tracked have been loaded onto a trailer, moved between trailers, picked up from a location, moved between locations, and/or delivered to a destination. To end, the CUI can provide customers delivery of any relevant documents associated with delivery to a destination. These documents can include documents (e.g., signature, delivery confirmation, or other documents) that have been sent by the fleet. Documents, data, and other inputs associated with customers can be accessed and used by other user interfaces and/or the system as will be briefly discussed below.

### Fleet User Interface (“FUI”)

Members of the fleet (e.g., drivers, dispatchers, and departments) can access and/modify information associated with fleet assets via the FUI. These fleet assets include customer assets (e.g., assets loaded/unloaded onto a trailer), truck assets (assets on a truck/trailer and/or the truck/trailer themselves), and fleet inventory (e.g., inventoried assets that may become truck assets). For discussion purposes only, below discussion of the FUI is from the vantagepoint of a fleet driver (sometimes referred to herein as “Drivers” or “Fleet Drivers”) for ease of reference and conciseness.

After a Driver logs in, they can access the FUI with several input options. Drivers can select from the following options: trailer inspection; overages, shortages, and damaged goods (“OS&D”); and workflow. Displayed among these options can be a variety of useful information, including current loads and orders. As shown here, each of the current loads and orders is shown with a status (in route, not in route, delivered), fleet, load weight, start/end date, and trip miles.

When trailer inspection is selected, the Driver can be directed to another page of the FUI to input certain information about the trailer. For instance, Drivers can input a load number, a trailer number, and upload one or more photos. Regarding the upload, the FUI can request that the Driver upload photos with various views (driver side, passenger side, front, and rear views) of the trailer and/or truck. These photos can serve as a log for the condition (damaged, undamaged) of the trailer and/or provide an indication of the severity of the condition of the trailer. This page can also have a field with which to freely input notes from the Driver While on this page, the load number and trailer number can be prominently displayed.

In a similar fashion to trailer inspection, when the Driver selects damaged goods, the FUI can request that the Driver upload photos with various views of the damaged goods. Other inputs and functions of this page can be similar to those discussed with reference to the trailer inspection.

Workflow can house many additional pages of the FUI. For instance, Drivers can select from the following options: view trip plan, fuel solution, navigation, configure navigation. While on this page, the following information can be prominently displayed: driver ID, trip status (started, finished, in progress), start date, and end date. Discussion now addresses said input options in turn.

View trip plan generally outlines stops for Driver along a given route. For instance, view trip plan can list out a portion of the stops for the Driver that are associated with an order number. Stops can be listed in order, and certain input (detention, tasks, and the like) selectable only for the current/upcoming stop so that stops are completed in the order presented. When selected by the Driver, prominently displayed on the page for each stop is a stop number, a stop order number, a stop event, a company stop ID, and address, a phone number, a trailer number, and arrival date, and a departure date, arrival status, departure status, and trip miles. Selectable for each stop is an option to input detention and to view tasks. Briefly, the Driver can select an input and arrival and departure time using the detention page if they are detained at a given stop for an extended period of time (e.g., longer than an expected stop time).

View tasks can function as a task manager that ensures a set list of tasks are completed at each stop based on the function of the stop (e.g., rest, fueling, and/or delivery). As noted above, stops can be listed in order so as to avoid out of order stops. In a similar fashion, tasks can be listed in order so as to avoid out of order tasks.

When view tasks is selected, the Driver can be prompted to input several pieces of information across a variety of options for each stop. At this page, the Driver can select from the following options: load at shipper, ETA (e.g., to the next stop), and departed. On the load at shipper page, the Driver may be presented with the page from manual input. For instance, the Driver can be prompted to input the trailer number, the PUP, the BOL, the weight, volume, the count, the temperature, the seal number, and whether the seal is intact. In addition, or an alternative, this information can be entered using the AIT. For instance, there can be a barcode associated with the seal number, the trailer number, and the like. What is more the assets inside the trailer can be managed using the AIT.

In examples, some for each asset inside the trailer can have a unique identifier for use with the AIT. Under these circumstances, the view tasks page can prompt the Driver to input the following information: whether the Driver has arrived a given stop, to scan barcodes of the trailer or of assets on the trailer, drop off (which is the same or similar inputs as the load to shipper page), and whether the Driver has departed the stop. In detail, scan barcode can navigate to a new page that displays a list of the barcodes that have been scanned using the terminal or connect device and the barcode values. Notably, the terminal can send an asset's unique identifier or information associated with the unique identifier to the asset management system to cross reference a customer reference list with assets to be tracked for delivery.

Using unloading as an example, the asset management system can reduce the quantity of assets on the customer reference list when a unique identifier is scanned and matched with an asset on the customer reference list. In examples, the Driver can disposition an asset as damaged, received, or refused and adjust the quantity of assets on the customer reference list accordingly. Upon completing the scan barcode task, the asset management system can send the customer notification of which assets arrived at the stop and their disposition along with any digital paperwork that the Driver may have uploaded in connection with the stop. In examples, loading can operate in the opposite manner where assets are scanned as they are loaded onto the trailer and cross referenced with the customer reference list.

Fuel solution can provide the Driver with an estimate of refueling stations to accomplish a given trip with a certain number of stops. Refueling stations on the trip can be estimated and presented with the highway, road, address, and or purchase amount. In instances, the asset management system may estimate how much fuel will be consumed on a trip using mechanic data of the instant truck, historical fuel consumption by other trucks with similar weights, and similar information to calculate a mile per gallon and historical pricing and fiscal environment data for fuel. As one skilled in the art will appreciate, this information can influence where the Driver should stop to refuel and the purchase amount of fuel. This information can be used to estimate the Drivers pay for certain loads. In addition, or an alternative, portions of this data may leverage artificial intelligence (e.g., big data, machine learning, and the like) to improve the accuracy of estimations over time.

Briefly, navigation can link to navigation or similar apps that are native or otherwise installed on the terminal. In this regard, configure navigation can include a list of user preferences (avoid highways, clearances of certain heights, tolls, default navigation application, and the like). In examples, the App can have its own navigation or integrate with GPS tracking services/apps such as COPILOT™.

### Mechanic User Interface (“MUI”)

As part of the system, mechanics can use the system to facilitate truck and/or fleet management. Truck(s) (or tractor(s)) in the system can include one or more truck assets that are managed through the AIT. These truck assets can include at least one of a trailer tracking device, an electronic logging device (“ELD”), and a toll device. These devices may be discrete or integrated into a single device pending on the use case. In either case, these devices can be integrated or otherwise communicate with the system. In particular, trailer tracking devices can be or otherwise serve as a receiver/transmitter for a terminal, similar to the ones discussed elsewhere herein. ELDs can function as an electronic logbook, e-log, or driver log. In this regard, ELDs can manually (e.g., with user intervention) or automatically record driving time to reliably collect Hours of Service data (e.g., duty status, daily logs, and generate electronic logs to present at roadside inspections). And toll devices can function as toll management services for paying electronic tolls or otherwise interfacing with toll management service providers.

The terminal can display a MUI. Input fields include the unit number, device type, and barcode value. These fields can be similar to similar fields discussed elsewhere herein. The MUI can function similarly to the FUI. In this regard, and similar to other assets discussed in detail above, the truck and the truck assets can be included in the MT. As such, the truck can be associated with trucks assets that are installed, uninstalled, or otherwise serviced. In this manner, fleet operators can manage their assets with the help of mechanics who use the MUI.

The MUI includes several input fields that can be similar to other input fields discussed elsewhere herein. For instance, the illustrated MUI includes the following input fields: send or resend documents to a fleet department (in this instance, Road Service or Safety) and scan barcodes. If scan barcodes is selected, the NUI can request input for the unit number, device type, and device value (which can be provided by scanning the barcode). Other functions and inputs are contemplated as a logical interpolation, equivalent, or extension of these principles and are included in the scope of this disclosure.

As used herein, terminal may refer to computing devices such as portable devices (e.g., phones, tablets, laptops), wearables, and the like. Terminal may also refer to stationary portals located at strategic points for the fleet or otherwise. As used herein user may refer to user input or input performed by a controller during autonomous operation of the asset management system. For instance, the toll management service may operate autonomously without any user input unless the user performs a manual override. Other functions discussed herein can function in a similar fashion depending on the application and use case.

Artificial intelligence and data processing features can be integrated into the App. For instance, the App can use data supplied from customers to give users information as to where they need to deliver product. This data can include company name, address, city, state, zip code, barcode data, times for when the driver should arrive at a location, and the like. Image data is also consumed and used for scanning paperwork, sending HR documents, trailer inspections, damaged products, compliance paperwork, road service documents, and the like.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps can be added or omitted without departing from the scope of this disclosure. Such steps can include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

In the detailed description herein, references to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus

While the present disclosure has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

We claim:

1. A system for unloading a tractor trailer that is loaded with assets, the system comprising:
a terminal having a display device and configured to read a unique identifier that is associated with each asset in the tractor trailer, the unique identifier including asset information, and
a server in communication with the terminal and a storage, the server configured to perform an unloading process that includes:
receiving at least one of indicia of the asset information from a reading of the terminal, receiving a manual input of the asset information, and choosing the asset information manually from a list of reference data displayed on the display device;
performing a data comparison of the asset information with reference data stored on the storage to thereby identify the asset in an inventory associated with the reference data; and
modifying the inventory based on the data comparison when the asset has reached a destination.

2. The system according to claim 1, wherein the system is configured to await a manual confirmation entry to start an unloading process.

3. The system according to claim 1, wherein the system is configured to intelligently perform a data comparison of at least one of an ETA, a fuel consumption, and an estimated pay with historical data that is referenced by the server and that corresponds to the ETA, the fuel consumption, and the estimated pay.

4. The system according to claim 1, wherein the terminal includes at least one of a barcode scanner, a QR code scanner, an OCR scanner, or an RFID chip reader.

5. The system according to claim 1, further comprising at least one of a trailer tracking device for tracking a truck assets associated with a truck that is moving the tractor trailer, an electronic logging device, and a toll device.

6. The system according to claim 1, wherein the terminal is provided by a mobile device.

7. The system according to claim 1, wherein the system is further configured to determine a fill level of the tractor trailer based on the data comparison.

8. The system according to claim 1, wherein the system is configured to check whether the tractor trailer is qualified for the assets.

9. The system according to claim 1, wherein the system further comprises a task list associated with at least one stop along a trip of the tractor trailer, the task list providing at least one of data indicative of the results of the data comparison, a time estimate to a subsequent stop, and a disposition of each asset delivered at the stop.

10. The system according to claim 1, wherein further comprising a fleet user interface, a mechanic interface, and a customer interface.

11. The system according to claim 1, wherein the server is further configured to display a list of barcodes associated with a given stop.

12. A method for unloading a tractor trailer that is loaded with assets, method system comprising:
reading a unique identifier that is associated with each asset in the tractor trailer, the unique identifier including asset information,
receiving at least one of indicia of the asset information from the reading, a manual input of the asset information, choosing the asset information manually from a list of reference data displayed on the display device;
performing a data comparison of the asset information with reference data stored on the storage to thereby identify the asset in an inventory associated with the reference data, and
modifying the inventory based on the data comparison when the asset has reached a destination.

13. The method according to claim 12, further comprising awaiting manual entry prior to the performing the unloading process and confirming the displayed asset information.

14. The method according to claim 12, further comprising generating a task list associated with at least one stop along a trip of the tractor trailer, the task list providing at least one of data indicative of the results of the data comparison, a time estimate to a subsequent stop, and a disposition of each asset delivered at the stop.

15. The method according to claim 12, further comprising determining a fill level of the tractor trailer based on the data comparison.

16. The method according to claim 12, further comprising displaying a list of barcodes associated with a given stop.

17. A control module for unloading a tractor trailer that is loaded with assets, the control module being configured to:
prompt a user to read a unique identifier that is associated with each asset in the tractor trailer, the unique identifier including asset information, and
receive at least one of indicia of the asset information, a manual input of the asset information, and user selection of asset information manually selected from a list of reference data displayed on the display device,
perform a data comparison of the asset information with reference data stored on the storage to thereby identify the asset in an inventory associated with the reference data; and
modify the inventory based on the data comparison when the asset has reached a destination.

18. The control module according to claim 17, wherein the control module is further configured to await manual entry prior to the performing the unloading process and confirming the displayed asset information.

19. The control module according to claim 17, wherein the control module is further configured to generate a task list associated with at least one stop along a trip of the tractor trailer, the task list providing at least one of data indicative of the results of the data comparison, a time estimate to a subsequent stop, and a disposition of each asset delivered at the stop.

20. The control module according to claim 17, wherein the control module is further configured to determine a fill level of the tractor trailer based on the data comparison and to display a list of barcodes associated with a given stop.
